(19) United States
(12) Patent Application Publication
(10) Pub. No.: US 2010/0265708 A1
(43) Pub. Date: Oct. 21, 2010

(54) HEAT-DISSIPATING ASSEMBLY OF LED LAMP HOLDER

(76) Inventors: Kuo-Len Lin, Wugu Township (TW); Chen-Hsiang Lin, Wugu Townshiip (TW); Hwai-Ming Wang, Wugu Township (TW); Chiao-Li Huang, Wugu Township (TW); Ken Hsu, Wugu Township (TW); Chih-Hung Cheng, Wugu Township (TW)

Correspondence Address: HDLS Patent & Trademark Services, P.O. BOX 220746, CHANTILLY, VA, 20153-0746, US

(21) Appl. No.: 12/425,768

(22) Filed: Apr. 17, 2009

(51) Int. Cl. F21V 21/00

(52) U.S. Cl. 362/249.02

(57) ABSTRACT

A LED lamp holder includes a lamp cover and a heat-dissipating device provided in the lamp cover. An accommodating inlet is provided on the lamp cover. A LED unit is provided below the lamp cover. A cover plate covers the accommodating inlet. The heat-dissipating device includes a heat-absorbing plate, a heat-dissipating plate and a heat pipe connected between the heat-absorbing plate and the heat-dissipating plate. The heat-absorbing plate is brought into contact with the LED unit, while the heat-dissipating plate is brought into contact with the cover plate. The cover plate is penetrated by a plurality of screw elements. Each of the screw elements is screwed to the heat-absorbing plate. The length of each screw element exactly makes the heat-absorbing plate to abut and contact the LED unit.

### BACKGROUND OF THE INVENTION

1. Field of the Invention

The present invention relates to a LED lamp, and in particular to a heat-dissipating assembly of a LED lamp holder.

2. Description of Prior Art

Light-emitting diodes (LED) are widely used as light sources in lighting. However, since the LED is an electronic element, it has to be waterproof and dust-proof when being applied to an outdoor lamp. Further, the heat-dissipating performance of the LED has to be also taken into consideration.

The current heat-dissipating assembly in a LED lamp holder continues using a heat sink or heat-dissipating device in a computer host. A heat-conducting plate is brought into contact with a heat source. Then, heat pipes are connected to transmit the heat to the lamp cover or heat-dissipating fins, thereby cooling the heat source. However, the above-mentioned members have to be fixedly connected to each other with a superior heat-conducting effect, such as by means of tin paste or adhesive heat-conducting paste. Therefore, it is impossible to detach these members after being assembled together, which makes more difficult to replace the damaged components in the future. Since it is unable to replace the damaged components, the whole lamp holder should be replaced, which causes the waste in cost.

Therefore, in order to overcome the above problems, the present Inventor proposes a reasonable and novel structure based on his delicate researches and expert experiments.

### SUMMARY OF THE INVENTION

The present invention is to provide an assembly of a LED lamp holder. Without affecting the contact between a heat-dissipating device and a heat source of a LED unit, a detachable assembly is provided, so that the components within the LED lamp holder can be replaced. Especially, after being detached, the contact between the heat-dissipating device and the heat source of the LED unit will not be affected.

The present invention is to provide an assembly of a LED lamp holder, which includes a lamp cover and a heat-dissipating device provided in the lamp cover. An accommodating inlet is provided on the lamp cover. A LED unit is provided below the lamp cover. A cover plate covers the accommodating inlet. The heat-dissipating device comprises a heat-absorbing plate, a heat-dissipating plate and a heat pipe connected between the heat-absorbing plate and the heat-dissipating plate. The heat-absorbing plate is brought into contact with the LED unit, while the heat-dissipating plate is brought into contact with the cover plate. The cover plate is penetrated by a plurality of screw elements. Each of the screw elements is screwed to the heat-absorbing plate. The length of each screw element exactly makes the heat-absorbing plate to abut and contact the LED unit, and the respective screw elements can keep this state. The heat-dissipating device is assembled with the cover plate to form a detachable assembly.

### BRIEF DESCRIPTION OF THE DRAWINGS

FIG. 1 is a partially exploded perspective view of the present invention;

FIG. 2 is an assembled view showing the internal structure of the present invention;

FIG. 3 is an assembled view showing the heat-dissipating structure of the present invention; and

FIG. 4 is a cross-sectional view of the present invention.

### DETAILED DESCRIPTION OF THE INVENTION

In order to make the Examiner to better understand the characteristics and technical contents of the present invention, a detailed description relating thereto will be made with reference to the accompanying drawings. However, the drawings are illustrative only but not used to limit the present invention.

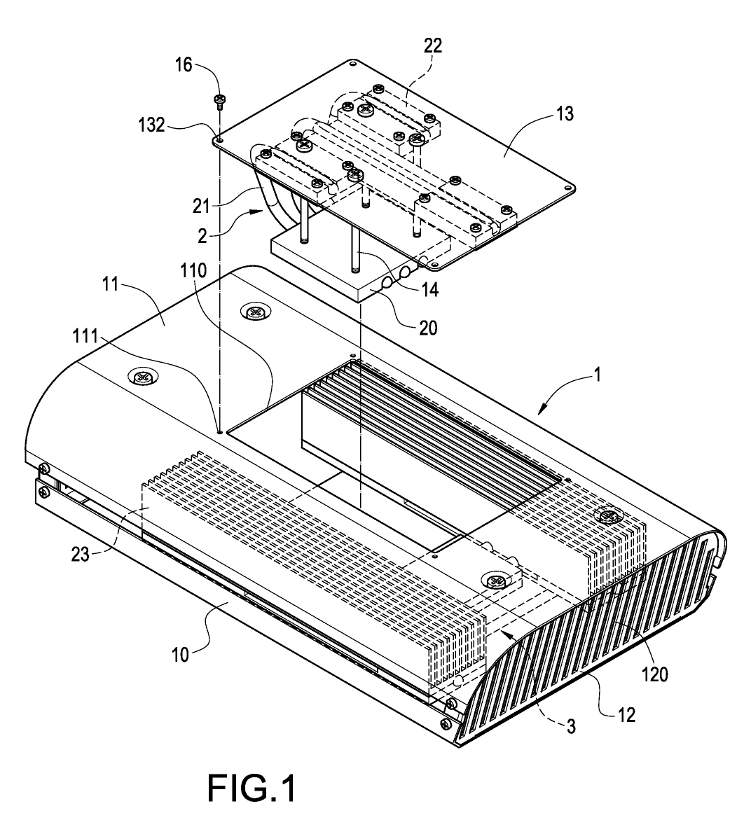

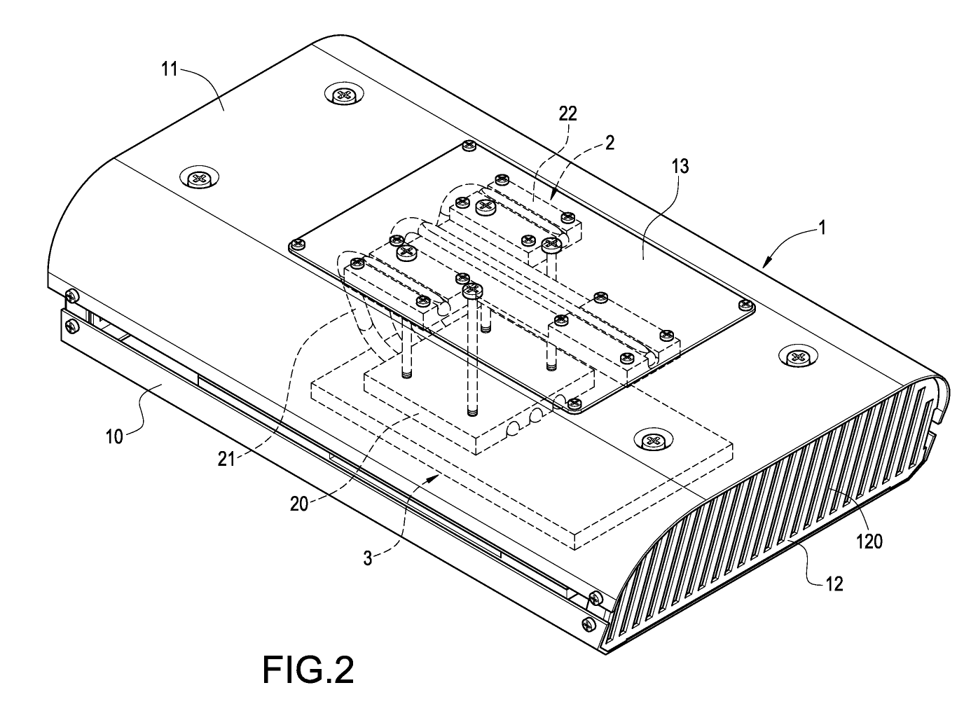

Please refer to FIGS. 1 and 2. FIG. 1 is an exploded perspective view of the present invention, and FIG. 2 is an assembled view showing the internal structure of the present invention. The present invention provides an assembly of a LED lamp holder, which includes a lamp cover 1 and a heat-dissipating device 2 provided in the lamp cover 1.

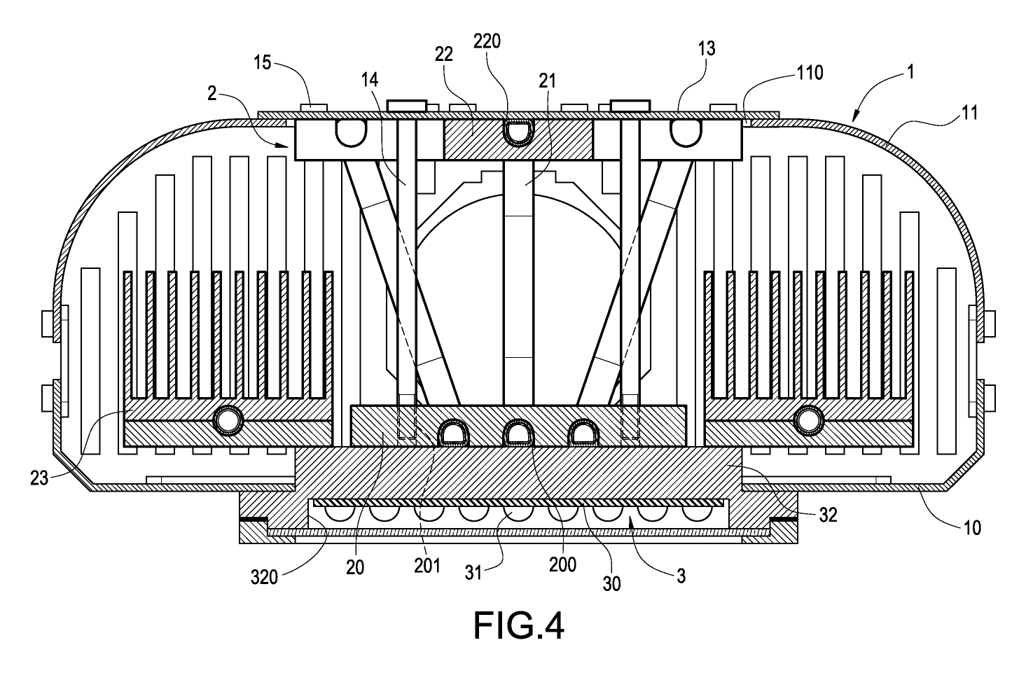

The lamp cover 1 is constituted of a base 10 and an upper cover 11. A LED unit 3 is disposed below the base 10. The LED unit 3 comprises a circuit board 30 and a plurality of light-emitting diodes 31 provided on the circuit board 30, so that the light emitted by each of the light-emitting diodes 31 of the LED unit 3 can project toward the underside of the lamp cover 1 (FIG. 4). Each of the front and rear sides of the base 10 is formed with an upright shielding plate 12. The slightly-curved upper cover 11 spans between the two shielding plates 12. Air holes 120 are provided on the shielding plate 12

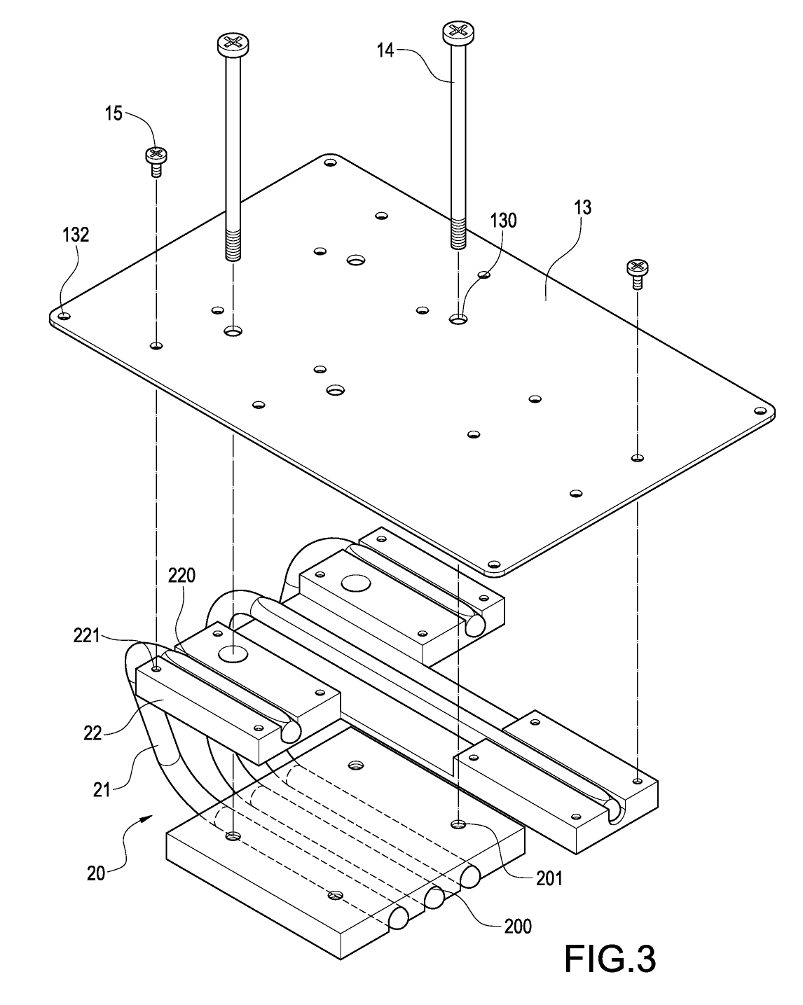

Please also refer to FIG. 3. The heat-dissipating device 2 is provided in the lamp cover 1 and comprises a heat-absorbing plate 20, at least one heat pipe 21 and a heat-dissipating plate 22. The heat-absorbing plate 20 is brought into contact with the back surface of the LED unit 3 to facilitate the heat dissipation of the LED unit 3. In the present embodiment shown in FIG. 4, on the back surface of the LED unit 3, a heat-conducting substrate 32 is adhered. The bottom surface of the heat-conducting substrate 32 is provided with a trough 320 for allowing the LED unit 3 to be accommodated in the trough 320.

According to the above, the heat-absorbing plate 20 is provided with at least one groove 200 for allowing one end of the heat pipe 21 to be embedded therein. The groove 200 is preferably located on the bottom surface of the heat-absorbing plate 20, so that it can be adhered to the heat source of the LED unit 3 more closely. Further, the heat-dissipating plate 22 is provided with at least one groove 220 for allowing the other end of the heat pipe 21 to be embedded therein. The groove 220 is preferably located on the top surface of the heat-dissipating plate 22, so that it can be further distant from the heat source of the LED unit 3. On the other hand, as shown in FIG. 1, the upper cover 11 of the lamp cover 1 is provided with an accommodating inlet 110 that is positioned to correspond to the heat-dissipating device 2 for allowing the heat-dissipating device 2 to pass through. A cover plate 13 covers the accommodating inlet 110. The heat-dissipating plate 22 of the heat-dissipating device 2 is adhered to the underside of the cover plate 13.

According to the present invention, the cover plate 13 is assembled to the upside of the heat-dissipating device 2. Then, via the accommodating inlet 2, the heat-dissipating device 2 is assembled in the lamp cover 1, so that the underside of the heat-dissipating device 2 can be brought into contact with the heat source of the LED unit 3. At this time, a plurality of screw elements 14 such as bolts are used to penetrate the cover plate 13 to be screwed on the heat-absorbing plate 20. In the present embodiment, the cover plate 13 is provided with through-holes 130 for allowing the screw elements 14 to pass through. Further, the heat-absorbing plate 20 is provided with screw holes 201 for allowing the screw elements 14 to be screwed therein. In addition, the cover plate 13 is provided with through-holes 131 for allowing screws 15 to pass through. The through-holes 131 are positioned to correspond to the screw holes 221 on the heat-dissipating plate 22, so that the cover plate 13 and the heat-dissipating plate 22 can be brought into contact with each other via the screws. Further, when the cover plate 13 covers the accommodating inlet 110, screws 16 may pass through the through-holes 132 to fasten the upper cover 11 to screw holes 111 near the periphery of the accommodating inlet 110, thereby completing the assembly.

According to the above, as shown in FIG. 4, the length of the screw element 14 is preset to make the heat-absorbing plate 20 abut the back surface of the LED unit 3 or contact the top surface of the heat-conducting substrate 32. In this way, when the heat-dissipating device 2 and the cover plate 13 are assembled on the upper cover 11, the heat-absorbing plate 20 of the heat-dissipating device 2 can be brought into contact with the heat source of the LED unit 3 surely. Also, the present invention forms a detachable assembly, so that it is convenient to replace the components within this assembly in the future.

According to the above, via the above constitution, the assembly of LED lamp holder of the present invention can be achieved.

Therefore, according to the assembly of the LED lamp holder of the present invention, since each of the screw elements 14 has an exact length to make the heat-absorbing plate 20 of the heat-dissipating device 2 abut and contact the LED unit 3. Further, via the respective screw elements 14, the above-mentioned state can be kept. Thus, the heat-dissipating device 2 is assembled with the cover plate 13 to form a detachable assembly. Even after detachment and re-assembly, the respective screw elements 14 can still maintain the contact between the heat-absorbing plate 20 and the LED unit 3. Alternatively, a layer of heat-conducting medium such as heat-conducting paste (not shown) can be applied between the heat-absorbing plate 20 and the back surface of the Led unit 3 (or the top surface of the heat-conducting substrate 32). Further, the heat-dissipating device 2 is additionally provided with other heat-dissipating members 23 on the inner periphery of the lamp cover 1.

According to the above, the present invention already achieves the desired objects and overcomes the problems of prior art. Thus, the present invention really demonstrates novelty and inventive steps and confirms to the requirements for a utility model patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An assembly of LED lamp holder, comprising:
a lamp cover with an accommodating inlet on a upside thereof and a LED unit on a underside thereof, a cover plate covering the accommodating inlet; and
a heat-dissipating device provided in the lamp cover and having a heat-absorbing plate, a heat-dissipating plate and a heat pipe connected between the heat-absorbing plate and the heat-dissipating plate, the heat-absorbing plate being brought into contact with the LED unit, and the heat-dissipating plate being brought into contact with the cover plate;
wherein the cover plate is penetrated by a plurality of screw elements, the screw elements are screwed on the heat-absorbing plate, and a length of each screw element exactly makes the heat-absorbing plate to abut and contact the LED unit and keeps this state.

2. The assembly of LED lamp holder according to claim 1, wherein the lamp cover is constituted of a base and an upper cover, the LED unit is provided under the base, and the accommodating inlet is located on the upper cover.

3. The assembly of LED lamp holder according to claim 2, wherein each of front and rear sides of the base is formed with an upright shielding plate, and the upper cover is curved and spans two shielding plates of the front and rear sides of the base.

4. The assembly of LED lamp holder according to claim 3, wherein air holes are provided on the two shielding plates.

5. The assembly of LED lamp holder according to claim 1, wherein the LED unit comprises a circuit board and a plurality of light-emitting diodes on the circuit board, a back surface of the circuit board is adhered with a heat-conducting substrate, and the heat-absorbing plate is adhered to the heat-conducting substrate and is brought into contact with the LED unit.

6. The assembly of LED lamp holder according to claim 5, wherein a bottom surface of the heat-conducting substrate is provided with a trough for allowing the LED unit to be embedded therein.

7. The assembly of LED lamp holder according to claim 1, wherein the cover plate is provided with through-holes for allowing respective screw elements to pass through, and the heat-absorbing plate is provided with screw holes for allowing the respective screw elements to be screwed therein.

8. The assembly of LED lamp holder according to claim 7, wherein the screw element is a bolt.

9. The assembly of LED lamp holder according to claim 1, wherein the screw element is a bolt.
